(19) United States
(12) Patent Application Publication
(10) Pub. No.: US 2020/0032529 A1
(43) Pub. Date: Jan. 30, 2020

(54) PAVING AND TILING APPARATUS

(71) Applicant: Mbarouk Rashid MBAROUK, Stockholm (SE)

(72) Inventor: Mbarouk Rashid MBAROUK, Stockholm (SE)

(21) Appl. No.: 16/592,174

(22) Filed: Oct. 3, 2019

Related U.S. Application Data
(63) Continuation of application No. PCT/IB2018/052354, filed on Apr. 5, 2018.

(30) Foreign Application Priority Data
Apr. 5, 2017 (GB) 1705455.2

(51) Int. Cl. E04F 21/18; B65G 47/90

(52) U.S. Cl. CPC E04F 21/1844; B65G 47/90

(57) ABSTRACT

A paving and tiling apparatus is provided for the improved paving and tiling of floors and walls. The paving and tiling apparatus comprises, a first aperture arranged to receive paving and tiling materials; a second aperture arranged to supply paving and tiling materials; at least one conveyor element arranged to transport paving and tiling materials from the first aperture to the second aperture; at least one drive means; and at least one guide member arranged to repeatably translocate between a primary receiving position, at least one intermediary position and a secondary releasing position. At the primary receiving position, the guide member may engage with paving and tiling materials. At the secondary releasing position, the guide member may disengage with paving and tiling materials. At least one intermediary position of the guide member is an optimum positioning of paving and tiling materials adjacent to a surface to be paved or tiled. The at least one drive means is arranged to drive at least one selected from the range: the at least one conveyor element, the at least one guide member. The paving and tiling apparatus provided enables faster and more efficient paving and tiling of floors and walls without the drawbacks associated with traditional methods such as the need for skilled workmanship or the likelihood of human exhaustion.

### CROSS REFERENCE TO RELATED APPLICATIONS

This application claims priority benefit from International Application No. PCT/IB2018/052354 filed on Apr. 5, 2018, which claims priority from Great Britain Application No. 1705455.2 filed on Apr. 5, 2017, each of which is incorporated herein by reference in its entirety.

### FIELD OF THE INVENTION

The present invention relates to a paving and tiling apparatus, in particular a paving and tiling apparatus arranged to aid the process of tiling a wall or paving a floor.

### BACKGROUND OF THE INVENTION

The construction industry is one of many that are of increasing importance to developing countries. Within these countries, there are many challenges faced by the construction industry. Such difficulties are caused by low labour efficiency, increasing accident rate at construction sites, poor workmanship or finishing ability, and insufficient supply of skilled labourers. The latter is of primary concern, with a resultant increase in employment of an international workforce becoming commonplace in many developing regions. There are also detrimental effects that can be associated with an increasingly foreign workforce, with the consequent flow of currency out of the region potentially contributing to a destabilising of the local economy.

Of the construction tasks requiring skilled workmanship, tiling is one of the oldest and is of increasing relevance to many developing regions across the world. In spite of age and prominence within the construction industry, the process of paving and tiling has not evolved substantially beyond the methods and processes carried out in the early days of practising the technique.

Persistent drawbacks exist even in modern tiling techniques due mainly to the necessity for skilled workers in regions where there is a skilled labourer shortfall. The repetitive nature of the tiling process together with the resulting time taken to carry out the work present other shortcomings.

Tasks following a standard repetitive protocol are an ideal subject for automation, and in recent times some progress has been made in automating the tiling process. A number of companies have made strides toward the production of robotic tiling machines. Examples of such automation can be found in CN204960260U. Automated devices present advantages such as improved rate of tiling, reduced cost of labour, reduced likelihood of injury or exhaustion, and reduced dependence upon skilled workmanship.

A key drawback to the automation of the tiling process, however, is that this often requires expensive machinery that is beyond the reach of typical businesses in many of the world's developing economies.

Aside from complete automation, there has been little progress in the development of a single apparatus for use by the individual labourer to aid and assist in the multi-step process of tiling and paving. Such an apparatus would overcome a number of the issues presented by current methods of tiling in developing regions, such as those previously discussed.

It is therefore desirable to provide an apparatus that is accessible to businesses within a developing economy and overcomes the shortfalls of current tiling and paving processes in those regions. Such an apparatus should ideally be inexpensive and operable by a single user, and ideally enable tiling and paving of walls and floors in a quick and precise manner, without the operation of the apparatus being excessively burdensome or required skilled workmanship.

### SUMMARY OF THE INVENTION

In accordance with the present invention, there is provided a paving and tiling apparatus comprising, a first aperture arranged to receive paving and tiling materials; a second aperture arranged to supply paving and tiling materials; at least one drive means; at least one conveyor element arranged to transport paving and tiling materials from the first aperture to the second aperture; and at least one guide member arranged to be driven by the drive means so as to repeatably translocate between a primary receiving position, at least one intermediary position and a secondary releasing position; wherein at the primary receiving position, the guide member is brought into engagement with paving and tiling materials; wherein at the secondary releasing position, the guide member is arranged to disengage from paving and tiling materials; wherein at least one intermediary position of the guide member is an optimum position for providing paving and tiling materials adjacent to a surface to be paved or tiled and urging said materials to engage with said surface.

The apparatus in accordance with the present invention is arranged to accept tiling and paving materials into the conveyor element through the first aperture. Optionally the conveyor element may include a reservoir, wherein the tiling and paving materials may be installed into the reservoir of the conveyor element prior to being transported to the second aperture. Preferably the reservoir is structured such that it may accept a variety of sizes and shapes of tiling and paving materials. Optionally the dimensions of the reservoir may be adjusted in order to provide facility for accepting tiling and paving materials of various shapes and sizes. The reservoir is preferably easily accessible to the inventor and enables the easy installation of tiling and paving materials to the conveyor element. The reservoir is preferably arranged to allow the bulk installation of tiling and paving materials and can accept individual tiling and paving materials and tiling and paving materials grouped together. Upon loading of the tiling and paving materials into the conveyor element of the apparatus, the conveyor element is configured to transport the tiling and paving materials to the second aperture, which may be through the use of a drive means. The drive means is preferably driven by hand, but may also be driven by other means, such as through the use of an electric motor. A guide member is arranged to engage with tiling and paving materials at a primary receiving position. From the primary receiving position, the guide member is arranged to move engaged to the tiling and paving materials in a direction toward the desired tiling or paving location defined by one or more intermediary positions. Pressing of the tiling and paving materials against a surface is performed by the guide member, wherein the final position defines the secondary releasing position. At this position the guide member may disengage from the tiling and paving materials and may return to the primary receiving position. The guide member is driven by a drive means, which may be by hand or by any other means, for instance an electric motor.

The conveyor element is preferably driven by the drive means.

The transport of the tiling and paving materials from the first aperture to the second aperture is preferably performed by the drive means, which may be by hand or by any other means, such as an electric motor. In embodiments wherein a larger number of tiling and paving materials are being transported from the first aperture to the second aperture, the conveyor element is preferably driven by a drive means comprising an electric motor.

The guide member preferably comprises an arm arranged to rotate about an axis.

Preferably the compression of tiling and paving materials against a surface is carried out by the guide member, wherein the guide member comprises at least one arm arranged to rotate about a respective axis. Preferably the guide member comprises two arms arranged to rotate about their respective axes, wherein the two arms are arranged to work synergistically to compress tiling and paving materials against a surface.

In preferable embodiments, the apparatus further comprises a control means arranged to accept an input from a user and to control at least one selected from the range: the conveyor element, the drive means, the guide member. In more preferable embodiments the apparatus further comprises a processing element arranged to accept input information from the at least one input portion and provide operation instructions to the control means.

The control means preferably accepts a user input and controls at least one of the drive means, the conveyor element, and the guide member. Most preferably the control means controls all of the drive means, the conveyor element and the guide member. In preferable embodiment the control means comprises a control panel that enables a user to input control instructions to the control means. Alternatively these controls may be input from a processing element, based on a protocol selected by the user. The processing element is preferably enabled to provide instructions for the accurate tiling or paving of walls or floors. Optionally the processing element may accept data from additional sources of information such as sensors to more effectively instruct the accurate and efficient tiling or paving of a surface. The sensed information may comprise positional information such as the position of the tiling and paving apparatus in relation to the desired surface.

Preferably the apparatus further comprises a positioning member arranged to position the apparatus at a desired position for tiling or paving. Preferably the positioning member is mechanised and controllable by the user using a control means.

The positioning member may comprise means to enable easy manoeuvrability of the apparatus, for instance wheels or tracks. Optionally the apparatus may be modular, wherein the apparatus comprised within the invention may be reversibly installed into the positioning member. Optionally the positioning member may be used to transport the apparatus to the desired surface. Preferably the positioning member is controlled using a control means. The positioning member may also comprise a display means, such as a monitor, in order to enable more accurate positioning of the tiling and paving apparatus adjacent the surface to be paved or tiled. The positioning member may also comprise sensing elements used to aid in the correct positioning of the tiling and paving apparatus. The sensing elements may optionally be used to sense parameters such as, for instance, location and proximity of the apparatus to the desired location on the surface to be paved or tiled.

Preferably the first aperture and the second aperture are co-located.

In preferable embodiments the first aperture and the second aperture are co-located, wherein tiling and paving materials are provided to the conveyor element through the first aperture, and the conveyor element may retreat the tiling and paving materials into the body of the apparatus. The conveyor element may optionally then provide the tiling and paving materials to the second aperture, either together or one at a time, in order to be engaged by the guide member in the primary receiving position.

### BRIEF DESCRIPTION OF THE DRAWINGS

Specific embodiments will now be described by way of example only, and with reference to the accompanying drawings.

The accompanying drawings, which are incorporated in and constitute a part of the specification, illustrate embodiments of the invention and together with the detailed description herein, serve to explain the principles of the invention. The drawings are only for purposes of illustrating preferred embodiments and are not to be construed as limiting the invention. It is emphasized that, in accordance with the standard practice in the industry, various features are not drawn to scale. In fact, the dimensions of the various features may be arbitrarily increased or reduced for clarity of discussion. The foregoing and other objects, features and advantages of the invention are apparent from the following detailed description taken in conjunction with the accompanying drawings in which:

FIG. 1 shows a tiling a paving apparatus according to the present invention;

FIG. 2 shows an alternative embodiment of the tiling and paving apparatus of FIG. 1; and

FIG. 3 shows a further alternative embodiment of the tiling and paving apparatus of FIG. 1.

### DETAILED DESCRIPTION FOR CARRYING OUT THE INVENTION

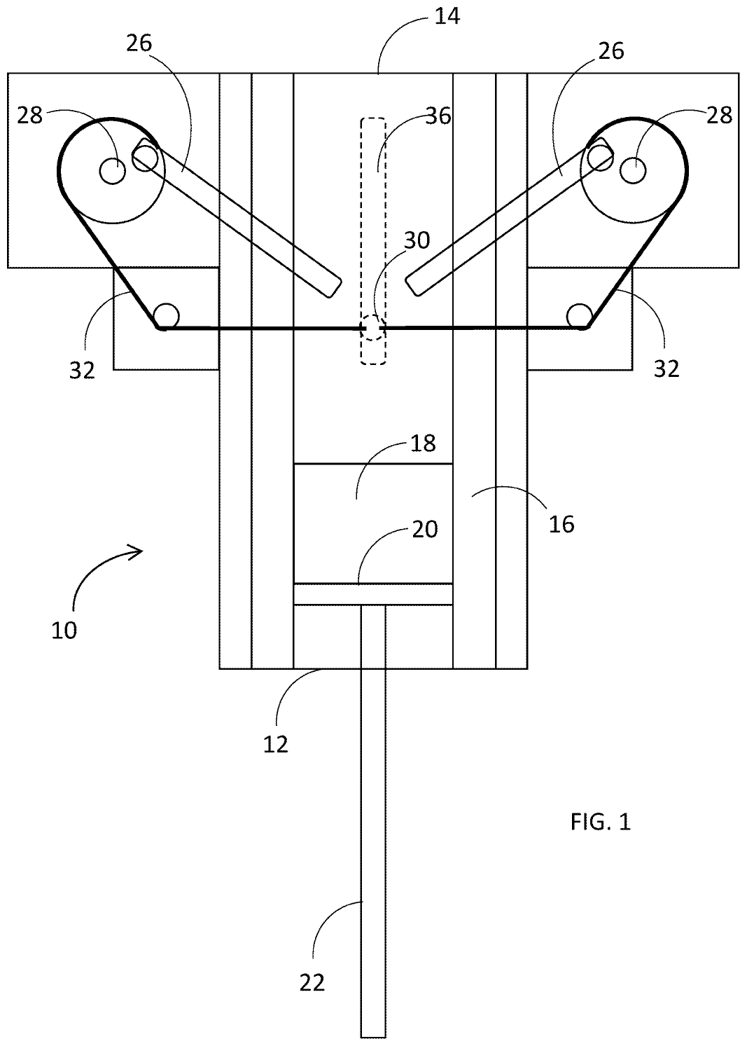

Referring to FIG. 1, a sectional diagram of a paving and tiling apparatus 10 is shown according to the present invention. The apparatus comprises a housing with a first aperture 12 located diametrically opposed a second aperture 14. In connection with each of the first aperture 12 and the second aperture 14 is a runway 16 comprising a conveyor element 18. A drive means 20 comprising handle 22 extends through the first aperture 12 into the runway 16 and is enabled to drive the conveyor element 18. Proximate the second aperture 14, and located at either side of the runway 16 are two guide members 24. Guide members 24 each comprise an arm 26 enabled to rotate about an axis by connection to a rotatable axle 28. The axle 28 is in communication with a handle 30 by way of a connection line 32. The handle 30 is arranged to move along a track 36 to provided tension to the connection lines 32 and to cause subsequent rotation of the axles 28. As such the handle 30, the connection lines 32 and the axles 28 comprise a drive means 44 for the rotation of the arms 26 of the guide members 24.

In use, the first aperture 12 is arranged to accept tiles onto the conveyor element 18. The handle 22 of the drive means 20 is actuated by hand and the conveyor element 18 is moved along the runway 16, delivering the tiles to the second aperture 14. When the conveyor element 18 is proximate the second aperture 14, the handle 30 of the drive means of the guide members 24 is actuated by moving the handle 30 along the track 36. The moving of handle 30 along the track 36 creates tension in the connection lines 32 and causes the axle 28 to rotate. The rotation of axle 28 causes arms 26 to make contact with a tile in a primary receiving position. The arms 28 rotate further through intermediary positions to compress the tile against a surface. Upon complete compression, the guide members 24 have reached the secondary releasing position, wherein the guide members 24 are enabled release from engagement to the tiles and return to the primary receiving position.

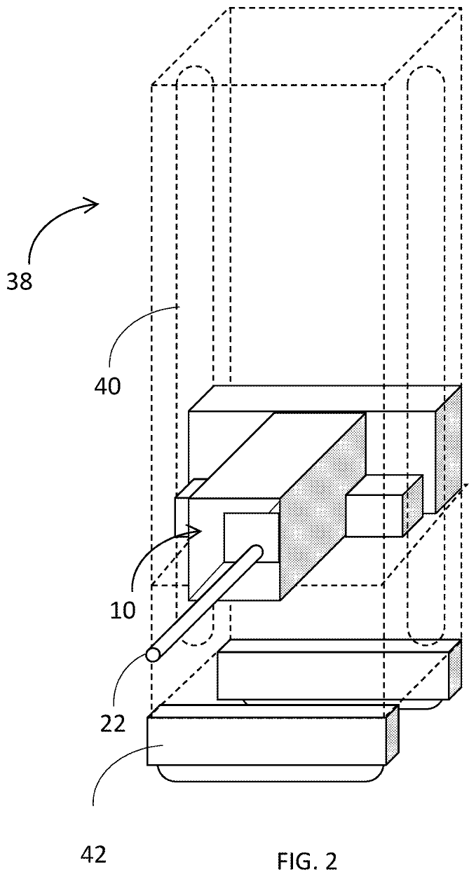

According to a preferable embodiment of the present invention shown in FIG. 2, there is shown a perspective drawing of the apparatus further comprising a positioning member 38. In the embodiment shown, the apparatus 10 is coupled to a positioning member 38, wherein the apparatus 10 is enabled to move orthogonally using the positioning member 38. In the embodiment shown, the apparatus 10 is enabled to move on a vertical axis through the use of pulleys 40. The apparatus 10 is further enabled to move while coupled to the positioning member in a horizontal axis using the tracks 42. The ability to move in both a vertical and horizontal axis enables the apparatus 10 to reach all areas of a wall.

In the embodiments shown, the apparatus 10 is enabled to compress tiles to a vertically positioned wall through movement in a vertical and horizontal axis. Alternative embodiments are available wherein the apparatus is enabled to optimise the paving of floors using paving materials and through the movement of the apparatus along two different horizontal axes.

In the embodiments shown, the apparatus is controlled by hand, wherein the movement of the positioning member 38 or the drive means 20 and 44 are controlled by hand. Alternative embodiments are available wherein the positioning member 38 and/or the drive means 20 and 44 are controlled by a control means and driven using a motor. In further alternative embodiments, the apparatus 10 is linked to a computer comprising a processing element, wherein input from a user into the computer is interpreted by the processing element and used to inform a change to the apparatus 10 or the positioning member 38 through instruction from the processing element to the control means. The informed changed may optionally be to at least one of the drive means of the apparatus 10 which in turn be used to drive the guide member, the conveyor element or both. Where the control means is used to control the positioning member 38, the control means may cause a change in the positioning of the apparatus 10 along either of the available axes.

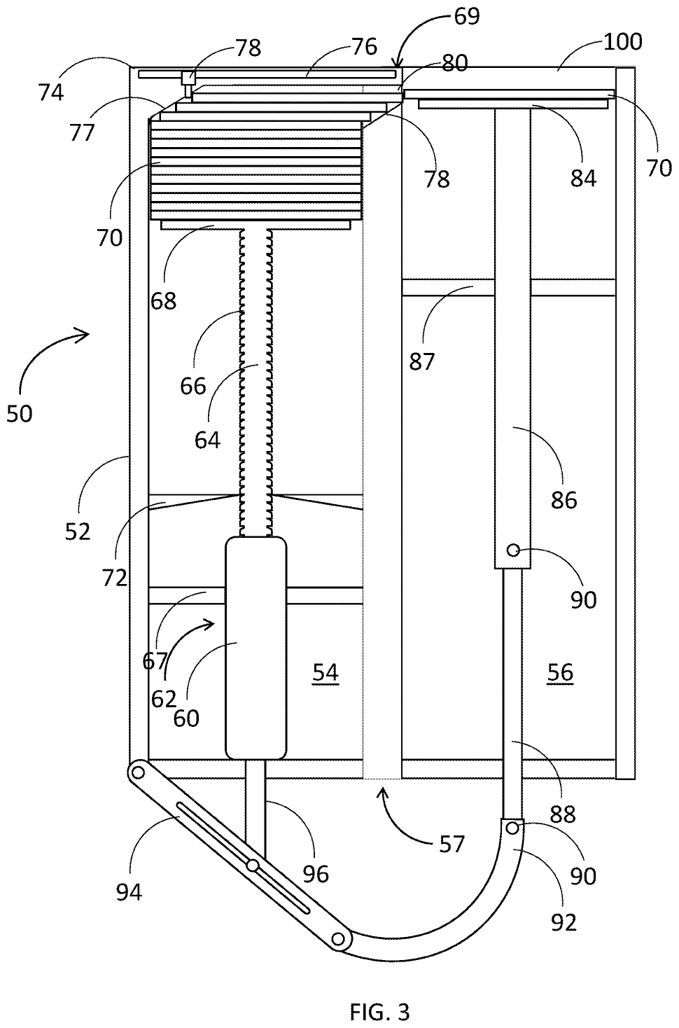

Referring to FIG. 3, an additional embodiment of a tiling and paving apparatus 50 is shown, the apparatus comprising a substantially cuboidal housing 52 having a first cuboidal chamber 54 and a second cuboidal chamber 56. The first chamber 54 and the second chamber 56 comprise an oblong cross section, the two shorter oblong sides defining a first end 57 and a second end 69 of the first chamber 54 and the second chamber 56, and the two longer oblong sides defining the walls of the first and second chambers 54, 56. Extending from the first end 57 of the first chamber 54 and positioned substantially centrally within the first chamber 54, is a conveyor element 58 comprising a jacket 60 housing a ratchet mechanism (not shown) in communication with a first end of an elongate first conveyor element 62, the first end being proximate the first end 57 of the first chamber 54. The jacket 60 and the elongate first conveyor element 62 are substantially aligned with the longitudinal axis of the first chamber 54. The elongate first conveyor element 62 comprises a shaft 64 having a substantially cylindrical cross section throughout, the shaft comprising a plurality of teeth 66 along the length of the shaft 64. At a second end of the elongate first conveyor element 62, and immovably affixed to the shaft 64, is located a planar member 68, the planar member 68 being oriented on an axis perpendicular to that of the shaft 66. Accommodated within the first chamber 54, and biased toward the second end 69 of the first chamber 54 by the planar member 68 of the elongate first conveyor element 62, are a plurality of planar tiles 70. The jacket 60 of the elongate first conveyor element 62 is fixed within the first chamber 54 using support struts 67.

Extending from the walls of the first chamber 54 are opposing locking pawls 72, positioned in contact with the shaft 64 of the elongate first conveyor element 62.

The second end 69 of the first chamber 54 is occluded by a ceiling 74 and comprises a first wedge portion 76 extending from a wall of the first chamber 54 to the ceiling 74. Comprised within the ceiling 74, and extending substantially along the length of the ceiling 74 is located a rail 76, comprising a second conveyor element 78, arranged to move reciprocally along the length of the rail 76 by a drive means (not shown). Proximate the second end 69 of the first chamber 54, and within a wall of the first chamber 54 opposing the first wedge portion 77 is a second wedge portion 78 extending from the wall of the first chamber 54 to a wall of the second chamber 56 defining an aperture 80 between the second wedge portion 78 and the ceiling 74. The aperture 80 provides access of tiles 70 to the second chamber 56 from the first chamber 54.

Extending from the first end 57 of the second chamber 56 is a guide member 82, the guide member 82 comprising a planar guide plate 84 affixed to a first end of a first elongate guide member 86. The first elongate guide member 86 is positioned centrally within the second chamber 56 and is oriented coaxial to the longitudinal axis of the second chamber 56. The first elongate guide member 86 is maintained in said orientation using support struts 87 affixed to the walls of the second chamber 56 and in slidable communication with the first elongate guide member 86. The second end of the first elongate guide member 86 is in rotatable communication with a first end of a second elongate guide member 88, using a pivot 90. The second end of the second elongate guide member 88 is in rotatable communication with a first end of a curved guide member 92. The second end of the curved guide member 92 is in rotatable communication with an elongate ratcheting member 94, which itself is in rotatable communication with a wall of the first chamber 54 and a push rod 96 extending within the jacket 60 of the elongate first conveyor element 62.

The second end 69 of the second chamber 56 is open and defines an aperture 100 sized to accommodate the transfer of tiles 70 from the second chamber 56, using the first elongate guide member 86.

In use, the device of the above described embodiment would be used to tile a wall which has had tiling mortar pre-applied. The shaft 64 of the elongate first conveyor element 62 is retracted such that the distance between the planar member 68 and the ceiling 74 is at a maximum, and planar tiles 70 are loaded into the first chamber 54 and biased against the ceiling 74 using the planar member 68. The curved guide member 92 is arranged to be driven by a drive means, and is driven such that the first elongate guide member 86 extends through the aperture 100, and out of the second chamber 56 onto a surface to be tiled. In the embodiment shown, the first action of the curved guide member 92 is sufficient to activate the ratcheting member 94 and push rod 96, such that the ratcheting mechanism comprised within the jacket causes the shaft 64 of the elongate first conveyor element 62 to extend. Simultaneously the drive means of the second conveyor element 78 is arranged to move the second conveyor element 78 along the rail 76 such that the tile 70 most proximate the ceiling 74 is urged through the aperture 80 and onto the planar plate 84. Such a priming may not be required in additional appreciable embodiments, wherein reloading the planar plate 84 with a tile 70 is automated ad not dependent upon action of the curved guide member 92. Biasing of the tiles 70 against the ceiling 74 by the ratcheting mechanism is maintained in the present embodiment by the action of the curved guide member 92.

Alternative embodiments will be appreciated wherein one or more walls of the first and/or second chamber are adjustable in one or more dimensions in order to accommodate tiles of varying sizes.

Additional embodiments will be appreciated wherein the apparatus 50 is incorporated into a larger device such as that shown in FIG. 2.

It will be appreciated that the above described embodiments are given by way of example only and that various modifications thereto may be made without departing from the scope of the invention as defined in the appended claims. For example the embodiments described involve an element of human interaction. Further embodiments will be conceivable wherein the process described requires no human interaction and is in fact automated using a combination of a processing element and a control means with the apparatus of the present invention.

In the embodiments described, tiles are used and the apparatus is used for tiling a vertical surface such as a wall. Alternative embodiments are possible wherein paving materials are instead used, and wherein the surface being paved is a floor. In such an embodiment the apparatus would be arranged in a vertical configuration, wherein the positioning member 38 is instead arranged to move positioned with its longitudinal axis parallel to the floor. In this embodiment, the tracks 42 would be positioned on the lengthwise edges of the positioning member 38 proximate the floor, enabling the positioning member 38 to move along the floor and allowing the tiling and paving apparatus 10 to moved orthogonally in order to pave or tile a desired region of the floor.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The invention has been described with reference to the preferred embodiments. It will be understood that the architectural and operational embodiments described herein are exemplary of a plurality of possible arrangements to provide the same general features, characteristics, and general system operation. Modifications and alterations will occur to others upon a reading and understanding of the preceding detailed description. It is intended that the invention be construed as including all such modifications and alterations.

1. A paving and tiling apparatus comprising,
a first aperture arranged to receive paving and tiling materials;
a second aperture arranged to supply the paving and tiling materials;
at least one drive means;
at least one conveyor element arranged to transport the paving and tiling materials from the first aperture to the second aperture;
and at least one guide member arranged to be driven by the drive means so as to repeatably translocate between a primary receiving position, at least one intermediary position and a secondary releasing position;
wherein at the primary receiving position, the guide member is brought into engagement with the paving and tiling materials;
wherein at the secondary releasing position, the guide member is arranged to disengage from the paving and tiling materials;
wherein at least one intermediary position of the guide member is an optimum position for providing the paving and tiling materials adjacent to a surface to be paved or tiled and urging said materials to engage with said surface.

2. The paving and tiling apparatus according to claim 1, wherein the conveyor element is arranged to be driven by the drive means.

3. The paving and tiling apparatus according to claim 1, wherein the guide member comprises an arm arranged to rotate about an axis.

4. The paving and tiling apparatus according to claim 1, wherein the apparatus further comprises a control means configured to accept input from a user and to control at least one selected from the range: the conveyor element, the drive means, the guide member.

5. The paving and tiling apparatus according to claim 4, wherein the apparatus further comprises a processing element arranged to accept input information from the at least one input portion and provide operation instructions to the control means.

6. The paving and tiling apparatus according to claim 1, wherein the apparatus further comprises a positioning member arranged to enable positioning of the apparatus into a desired location or position for paving or tiling.

7. The paving and tiling apparatus according to claim 6, wherein the apparatus further comprises a control means enabled to accept input from a user and to control the positioning member.

8. The paving and tiling apparatus according to claim 1, wherein the first aperture and the second aperture are co-located.
